(19) United States
(12) Patent Application Publication
(10) Pub. No.: US 2008/0135528 A1
(43) Pub. Date: Jun. 12, 2008

(54) Clamping Device For the Tool of a Machine Tool, Especially a Plunge Electrical Discharge Machine

(76) Inventors: Hakan Dahlquist, Hasselby (SE); Christer Modin, Kista (SE); Dick Ottosson, Spanga (SE)

Correspondence Address: BACHMAN & LAPOINTE, P.C., 900 CHAPEL STREET, SUITE 1201, NEW HAVEN, CT, 06510, US

(21) Appl. No.: 11/659,944

(22) PCT Filed: Jun. 13, 2005
(86) PCT No.: PCT/EP05/06306

§ 371 Date: Sep. 12, 2007

(30) Foreign Application Priority Data
Aug. 26, 2004 (EP) 04020227.7

(51) Int. Cl. B23H 7/26; B23Q 16/08; B23Q 1/00

(52) U.S. Cl. 219/69.15; 279/23.1; 29/592; 403/353; 403/279

(57) ABSTRACT

A clamping device, having a first and a second coupling part, for the tool of a machine tool. The first coupling part is eccentric and comprises small rails having angular off-sets in relation to each other and limiting surfaces for exactly positioning the second coupling part in the xy plane. The second coupling part comprises lateral faces having elastic lips which rest against the limiting surfaces, a connecting device is used to exactly position the first and the second coupling part in the z plane. The second coupling part consists of a piece having various strength values, ductility values and/or hardness, whereby the areas of the lips have higher strength values, ductility values and/or harnesses than the other areas of the lips and/or areas of the second coupling part.

### BACKGROUND OF THE INVENTION

The invention relates to a clamping device and a production method for a tool on a machine tool, comprising a first and a second coupling part, the first coupling part having strips which are offset eccentrically and at an angle to one another and have boundary surfaces for the accurate x-y positioning of the second coupling part, the second coupling part having side surfaces with elastic lips for bearing against the boundary surfaces, and a connecting device being provided for the accurate z positioning of the first and the second coupling part.

European Patent EP 0 255 042 discloses a clamping device for a tool for a machine tool, especially a plunge electrical discharge machine. The clamping device comprises a chuck which has two strips which project from the underside of the chuck and are provided with bearing surfaces for orienting the tool in an x direction and a y direction, which point transversely to a center line of the chuck. In order to be able to repeatedly locate the tool in a predetermined position on the chuck as often as desired and in each case with exceptionally high accuracy, provision is made for a plurality of posts to project from the underside of the chuck, said posts having reference surfaces extending on their free end faces in the x-y plane, the strips being designed to be offset eccentrically and at an angle to one another, and for a tool holder for bearing against the posts to have a planar surface in which two pairs of grooves aligned with the strips and having elastic lips provided for bearing against the strips are cut, the tool holder having a center bore with locking means for accommodating a draw bolt in a locking and releasable manner.

There are clamping systems in which both the coupling part serving as chuck and the other coupling part are used as a holder for tools. The holder is also intended to be used for workpieces. The two coupling parts were hitherto in each case produced, processed and hardened separately, a plane surface being provided with holes for fastening work holders, i.e. at least two parts are necessary in order to produce a frictional connection with the respective coupling part and a tool. This requires additional production processes for the complete clamping system.

The object of the invention is to improve the clamping device in order to simplify the production and make it cost-effective without interposing separate parts which serve to fasten workpieces or tools.

### SUMMARY OF THE INVENTION

According to the invention, this object is achieved in that the second coupling part consists of a single piece having various strength values, ductility values and hardness values, regions of the lips having higher strength values, ductility values and/or hardness values than the other regions of the lips and/or regions of the second coupling part.

Furthermore, the object is achieved according to the invention in that the first coupling part consists of a single piece having various strength values, ductility values and hardness values, regions of the strips having higher strength values, ductility values and/or hardness values than the other regions of the strips and/or regions of the first coupling part.

Furthermore, a method of producing a clamping device according to the invention serves to achieve the object, the first and/or the second coupling part first of all being produced, processed and formed in the unhardened state in relation to the application according to known methods and the surface being hardened.

The solution reduces the costs of the users and producers of the clamping device in such a way that the tool holder or the work holder is integrated in the one or the other coupling part and the user is able to process the tool holder or the work holder itself in the way he wants. One coupling part has the coupling side at the bottom region. A region for the tool holder or the work holder that can be freely processed is provided at the top region. The invention is not restricted to the processing by the user. It is likewise possible for the processing to be effected by the producer or his service department in a simple manner.

The invention relates to both coupling parts: either to the part having the strips or the part having the lips, depending on the how the coupling parts are used in each case as a chuck or as a holder for the tool or the workpiece. In the conventional chucks, it was necessary to repeatedly clamp and unclamp the respective coupling parts for the processing, e.g. for hardening after the processing.

The processing of the soft regions of the coupling parts is suitable for all conceivable functions and forms.

As described above, the essence of the invention is to design one of the two coupling parts in such a way that the fastening device for tool or workpiece is integrated in the respective coupling part in one piece. The single part is produced with regions having various material properties, such as strength, elasticity, hardness, etc. Softer material properties on the tool free processing of the tool holder, such as forming, milling, punching, turning, etc. Due to the possibility of the free processing, the coupling parts having the tool-fastening devices can be produced in relation to the application.

The second coupling part is preferably produced from steel or from high-grade steel, and the side surfaces with the lips are surface-hardened, the thickness d of the hardened region being smaller than the thickness D of the lips.

The surface hardening is preferably used in the case of unalloyed steel according to the application. The thickness of the hardened layer then corresponds to the thickness d.

Furthermore, the second coupling part may be produced as a cast part from steel or from high-grade steel, the side surfaces with the lips likewise being surface-hardened, and the thickness d of the hardened region being smaller than the thickness D of the lips.

In a preferred embodiment, the second coupling part is produced from steel or from high-grade steel, and the side surfaces with the lips are hardened, and the thickness d of the hardened region can be set according to the application.

For example, the second coupling part having the lips is cast. Inductive hardening is then effected, which produces the thickness of the hardened layer.

In a preferred configuration of the invention, those ends of the lips which adjoin the strips are formed in such a way that edge contact, complete surface contact or partial surface contact is effected when the first coupling part is restrained together with the second coupling part.

The lips are preferably formed differently in the x, y and/or z direction.

The first coupling part is preferably produced from steel or from high-grade steel, and the surfaces and/or boundary surfaces are surface-hardened.

The first coupling part is advantageously produced as a cast part from steel or from high-grade steel, the surfaces and/or boundary surfaces being surface-hardened.

Likewise, the first coupling part may be produced from steel or from high-grade steel, the surfaces and/or boundary surfaces being surface-hardened, and it being possible for the thickness of the hardened regions to be set according to the application.

The clamping device preferably has a connecting device for frictionally connecting the first coupling part to the second coupling part.

Various embodiments of the clamping device are described and shown in the subclaims and figures, respectively.

The first and/or the second coupling part can be produced according to the following methods:
the first and/or the second coupling part is first of all processed in the unhardened state and then hardened;
the first and/or the second coupling part is first of all hardened and then processed;
the first and/or the second coupling part is first of all produced as a cast part, and the surface is hardened and then processed;
the first and/or the second coupling part is first of all produced as a cast part and processed, and then the surface is hardened.

### BRIEF DESCRIPTION OF THE DRAWINGS

The invention is shown below in the attached drawings, in which:

FIG. 1 shows the two coupling parts in plan view and side view,

FIG. 2 shows the restrained clamping device in side view,

FIG. 3 shows the contact region of the lip and of the strip enlarged (region A),

FIG. 4a to FIG. 4b show various embodiments of the lips,

FIG. 5a to FIG. 5g show various profiles of the lips,

FIG. 6a and FIG. 6b show lips having various material properties,

FIG. 7a and FIG. 7b show side surfaces having various material properties,

FIG. 8 to FIG. 17 show various applications and embodiments of coupling parts.

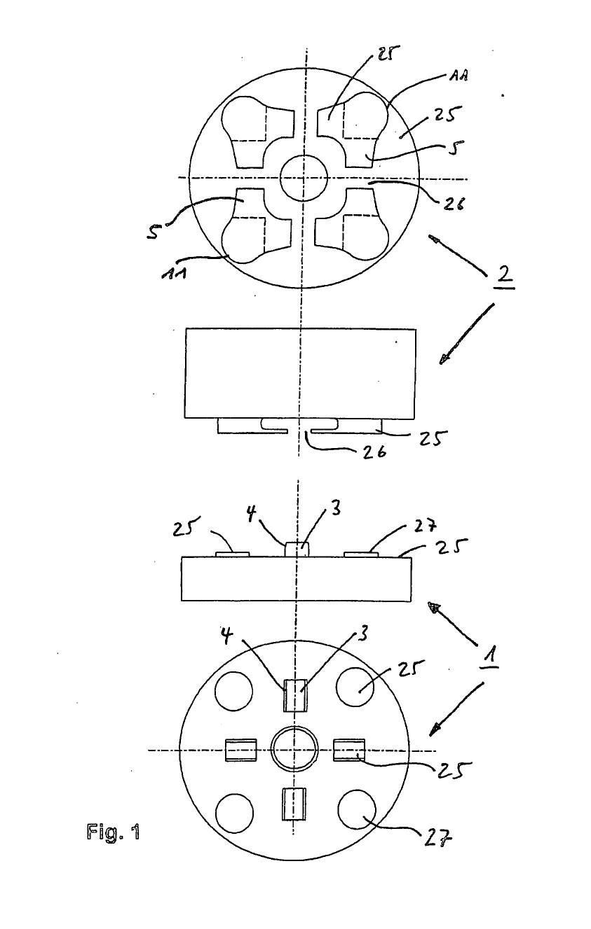

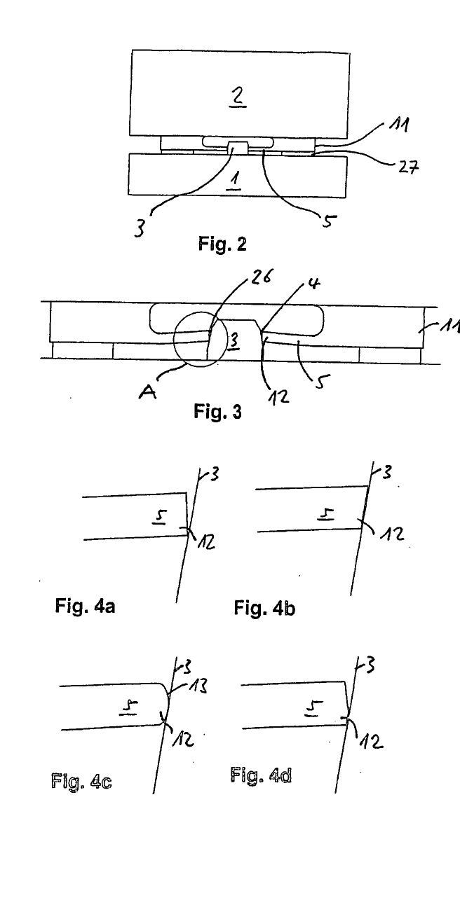

FIG. 1 shows the two coupling parts 1, 2 known per se in plan view and side view. The top part of FIG. 1 shows the second coupling part 2 with the side surfaces 11 and the lips 5. The first coupling part 1 with the strips 3 and their boundary surfaces 4 is shown in the bottom region of FIG. 1. In the restrained state, the strips 3 rest in the intermediate spaces 26 formed by the lips 5, as shown in FIG. 2 and enlarged in FIG. 3. The invention is not restricted to a specific type of coupling.

The two coupling parts may be effected in a manner known per se, such as, for example, by simple, central screwed connection, by a draw bolt which can be operated by means of a pneumatic or hydraulic draw-in device, a bayonet fastener, by means of balls which are provided in the radial direction and engage in grooves provided for this purpose, or other applicable methods.

It is essential to the invention that the coupling parts 1 and 2 having the side surfaces 11, the lips, the strips 3, the z seatings 27 or other application-related designs 5 described with respect to the following figures are first of all produced in one piece and processed from a soft material. Hardening may then be effected, the depth of the hardened region 25 being freely selectable with regard to the application. This can be applied, for example, in automatic production, in which there is the possibility of inductive hardening.

The invention can also be applied to a type of coupling in which the z references are positioned on the side surfaces or in which the z references and the x-y references lie in one plane.

FIGS. 4a to 4d represent various embodiments of the enlarged region A of FIG. 3. The deformation of the lips 5 can be seen in FIG. 3. In FIG. 4a, the lip end 12 of the lip 5 is configured in such a way that edge contact occurs during the restraint, in contrast to FIG. 4b, according to which surface contact is shown. The end 12 of the lip 5 in FIG. 4c has a curvature 13, and the end 12 of the lip 5 in FIG. 4d is designed in such a way that only a section of the lip end is in contact with the strip.

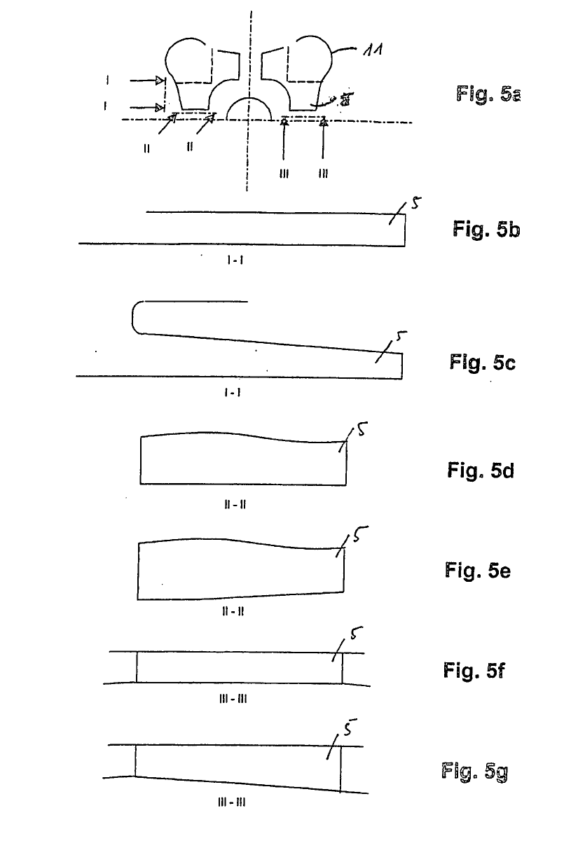

Various lip profiles are shown in FIGS. 5a to 5g. FIG. 5b shows the known lip profile along line I-I in FIG. 5a having constant thickness and FIG. 5c shows said lip profile having variable thickness, as viewed in the longitudinal direction. FIGS. 5d and 5e show the lip profile in direction II-II in FIG. 5a. These curved profiles result in better rigidity of the coupling. FIGS. 5f and 5g shows a combination of the profiles along line III-III in FIG. 5a.

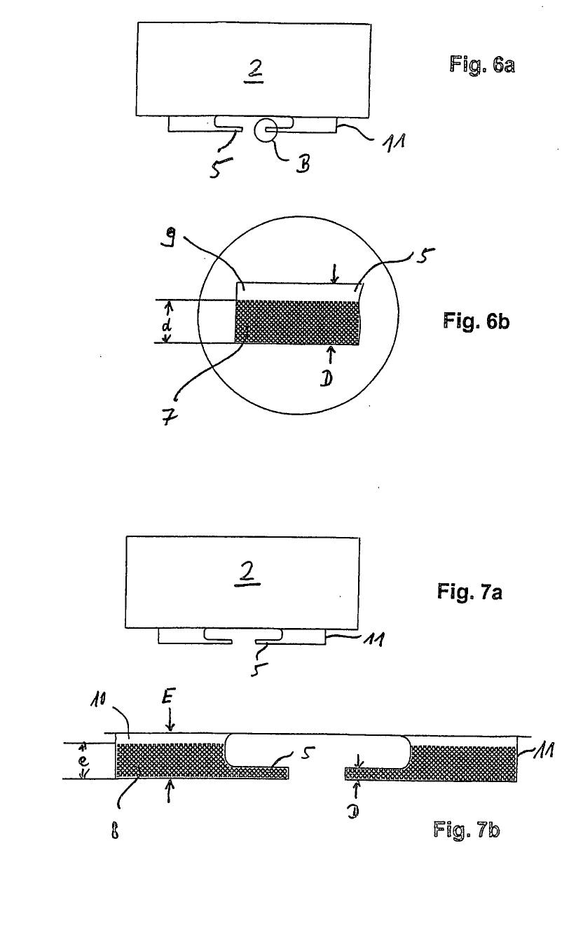

FIGS. 6a and 6b show the second coupling part 2 having the side surface 11 and the lip 5. In detail B, the lip 5 is shown in FIG. 6b with various material properties. The hatched region 7 of the lip 5 is hardened, the thickness d of the hardened region being smaller than the thickness D of the lip 5, a precondition for the possibility of forming the lips by known processing methods. The section 9 of the lip 5 remains unhardened and therefore soft.

The embodiment shown in FIGS. 7a and 7b shows a side surface 11 with the lip 5. Here, the thickness e of the hardened region 8 (hatched area) is smaller than the thickness of the side surface 11 but larger than the thickness D of the lip 5. The section 10 of the side surface 11 remains unhardened and therefore soft.

This embodiment is used, for example, in the case of cast coupling parts.

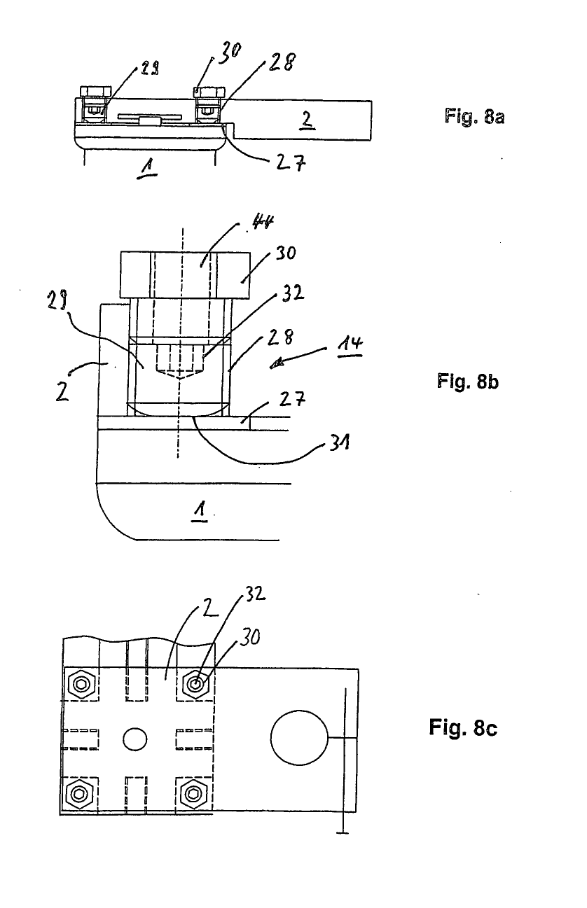

An application of a preferred embodiment for wire electrical discharge machines can be seen in side view, enlarged and in plan view in FIG. 8a to FIG. 8c. In the z seating 27, the coupling part 2 has holes 28 provided with threads. The coupling part 1 is restrained with the coupling part 2 in the manner described. The holes 28 accommodate adjusting screws 29 for setting the z direction. The adjusted level is locked by means of the check screws 30. The adjusting screw 29 may have a flat region 31 at the bottom end. The adjusting screw 29 has a hexagon socket connection 32. The locking screw 30 has a through-opening 44 for the adjusting screw 29 to be operated with a corresponding tool. The locking screw 30 is locked against the adjusting screw 29 by means of a hexagon key.

In the coupling part 2, all the z seatings may be provided with such an adjusting device 14.

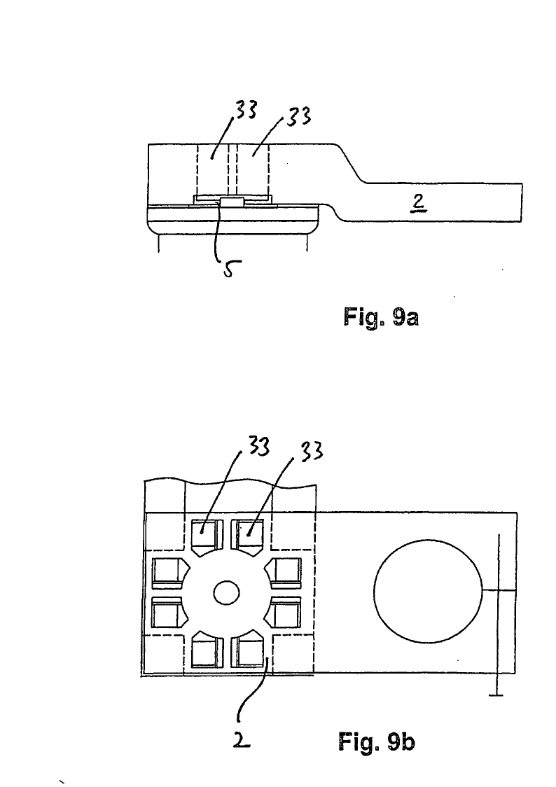

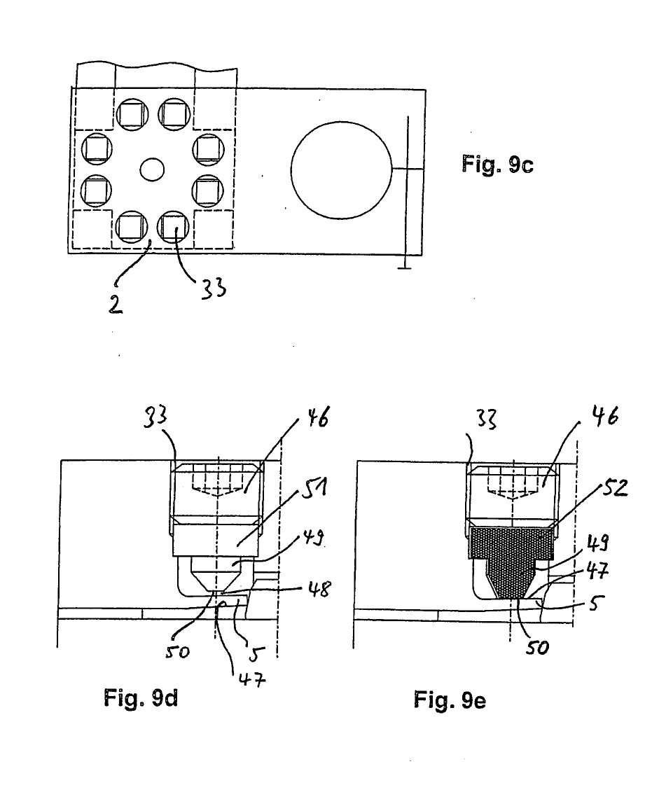

FIGS. 9a and 9b show a cast version of the coupling part 2 in side view and plan view. The coupling part 2 is designed in an S shape. The coupling part 2 has cast openings 33 above the lips 5. These openings 33 are especially advantageous for the accuracy of the cast coupling part 2.

Furthermore, it is advantageous that the lips 5 can be processed through the openings 33, since the lips 5, according to the invention, have a workable soft surface in the direction of the openings 33.

The openings 33 are shown square in FIG. 9b. They may likewise be cylindrical and if appropriate may be provided with threads on account of the surface softness, as shown in FIGS. 9c, 9d and 9e.

An adjusting device 46 is shown in FIG. 9d. The adjusting device 46 may be provided in all the openings 33 of the coupling part 2. The adjusting device 46 produces a mechanical stop which repeatedly shifts the lips 5 into the original position, in particular under high loads. Consequently, the connection of the two coupling parts 1 and 2 is very stiff. Permanent bending of the lips 5 is avoided with this adjusting device 46. It serves to set a gap 48 between the lip surface 47 and the bottom end 50 of the peg 51, which is acted upon by the adjusting screw 49 and whose bottom end 50 forms a stop for the lip surface 47.

The embodiment in FIG. 9e solves the problem of any possible vibrations of the lips 5, for example during the milling. In order to suppress these vibrations, which cause inaccuracies, a peg 52 of damping material, for example rubber or plastic, is provided.

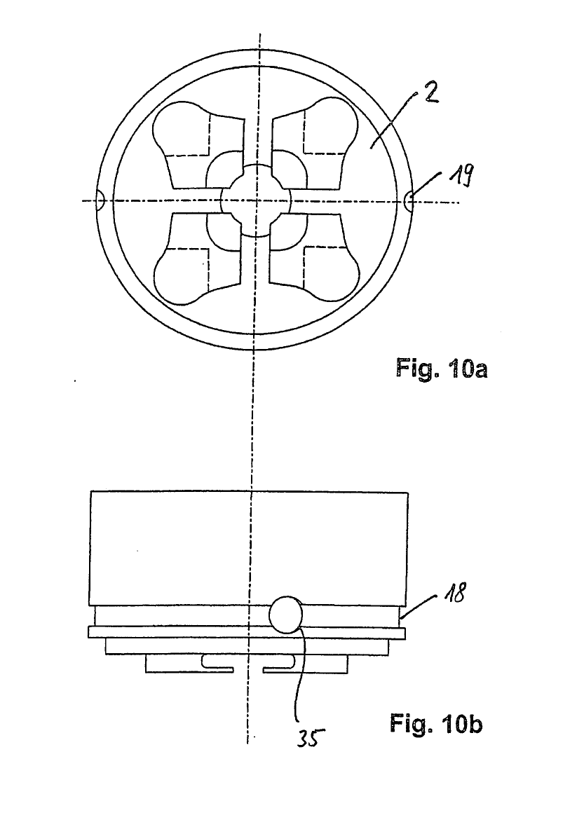

A coupling part 2 is shown in plan view and side view in FIGS. 10a and 10b. This coupling part 2 can be applied for automatic use in connection with robots. The coupling part 2 has a groove 18, in which a gripper of a robot can engage. The groove 18 has at least two notches 19 in order to avoid rotations during the gripping.

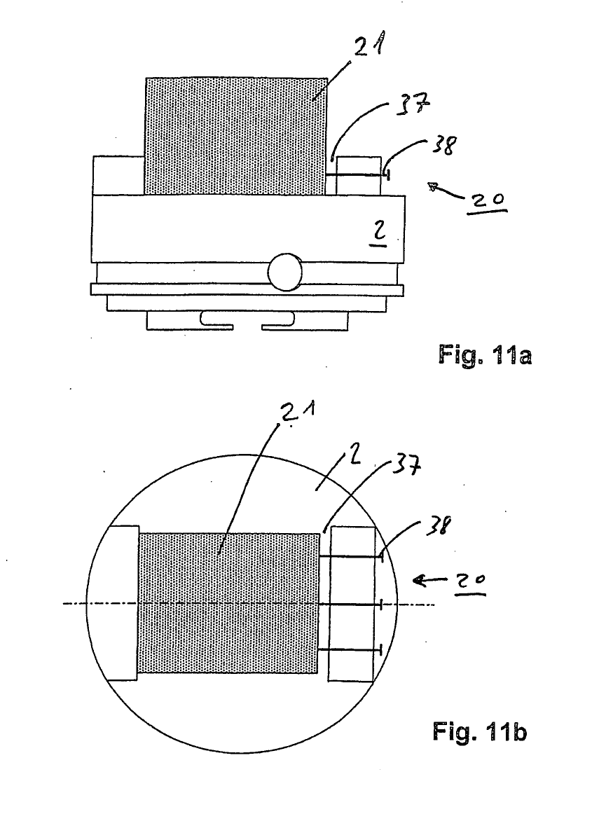

FIGS. 11a and 11b show a coupling part 2 having a device 20 for fastening workpieces 21 or tools. The device has an intermediate space 37 for clamping the workpieces 21. The workpieces 21 are clamped by means of screws 38 in the manner shown.

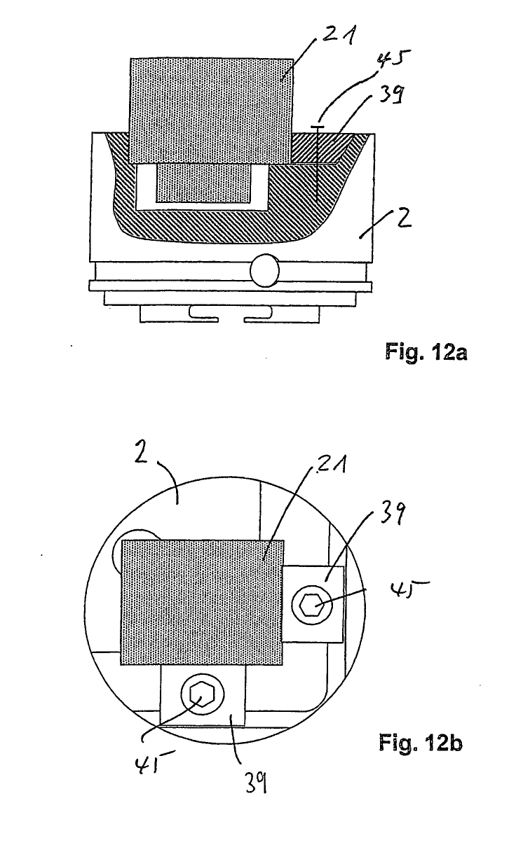

Another embodiment of a work holder having clamping jaws 39 is shown in FIGS. 12a and 12b. The clamping jaws 39 are adapted and arranged in accordance with the workpiece to be clamped. The workpiece 21 may be clamped, for example, via screws 45 which connect the clamping jaws 39 to the coupling part 2.

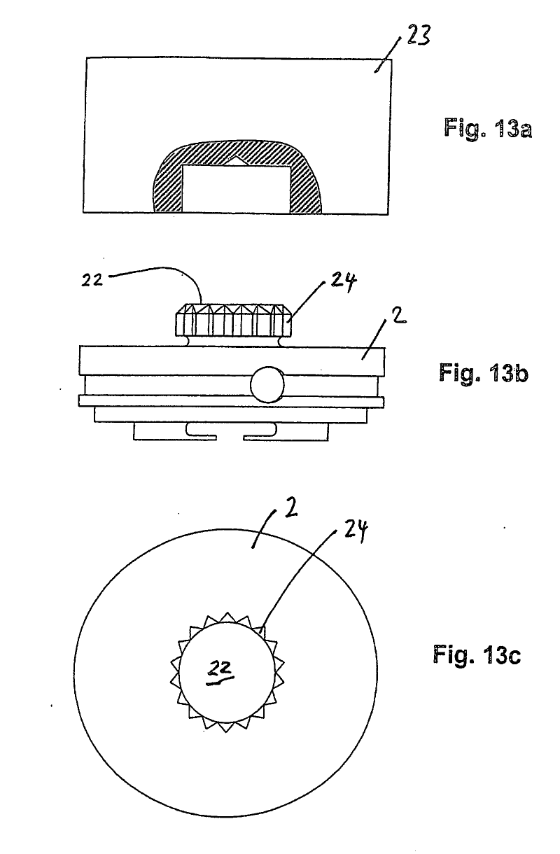

FIGS. 13a, 13b and 13c show a coupling part 2 having a shank 22 for accommodating an electrode 23, for example made of copper. According to the invention, the shank 22 is connected to the coupling part 2 in one piece. For firm anchoring and for achieving better electrical contact of the electrode, the shank 22 has splines on the circumference, which form a spline tooth system 24 with the electrode 23.

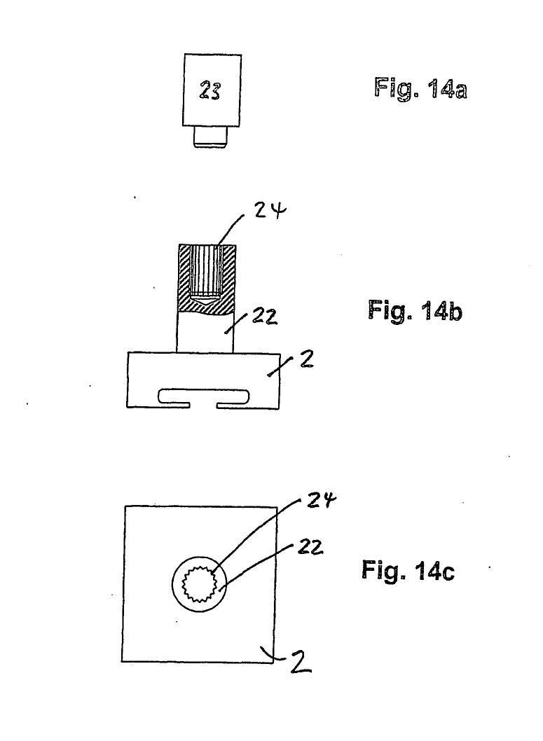

In accordance with FIGS. 13a, 13b and 13c, FIGS. 14a, 14b and 14c show a spline tooth system 24 with the electrode 23, the spline tooth system 24 being arranged inside the shank 22.

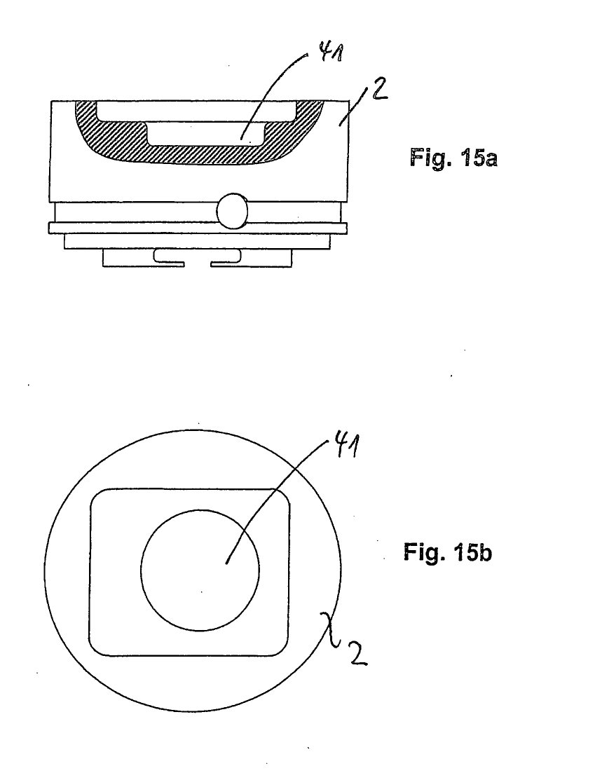

FIGS. 15a and 15b show a coupling part 2 having a workable cavity 41. The cavity is made of soft material and is therefore suitable for application-related processing, e.g. for wax patterns, precision forming. According to the invention, the surface can be hardened in relation to the application. This is a typical example according to the invention for the direct processing of a workpiece; repeated unclamping or re-clamping of the workpiece is not necessary.

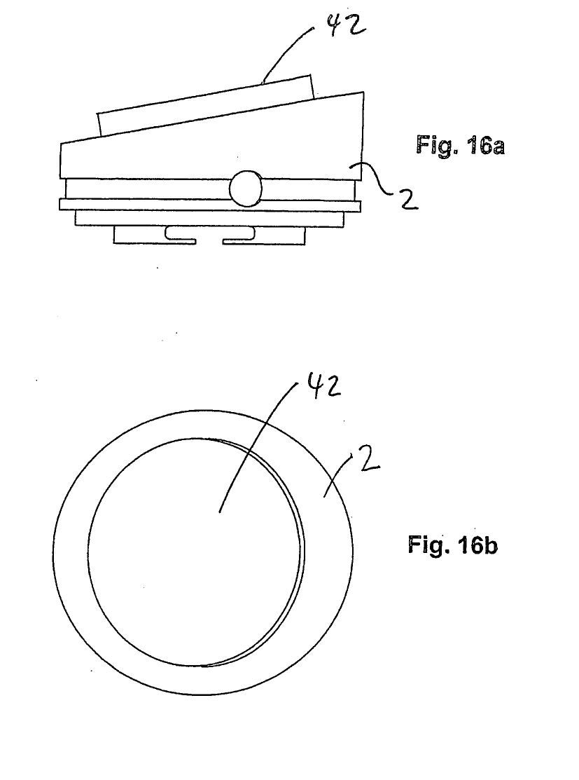

The coupling part in FIGS. 16a and 16b shows another function and form of the top soft region. The surface of the top region is processed in such a way that, for example, precise seating, at an exact angle, of a mirror 42 for optical measurements is achieved.

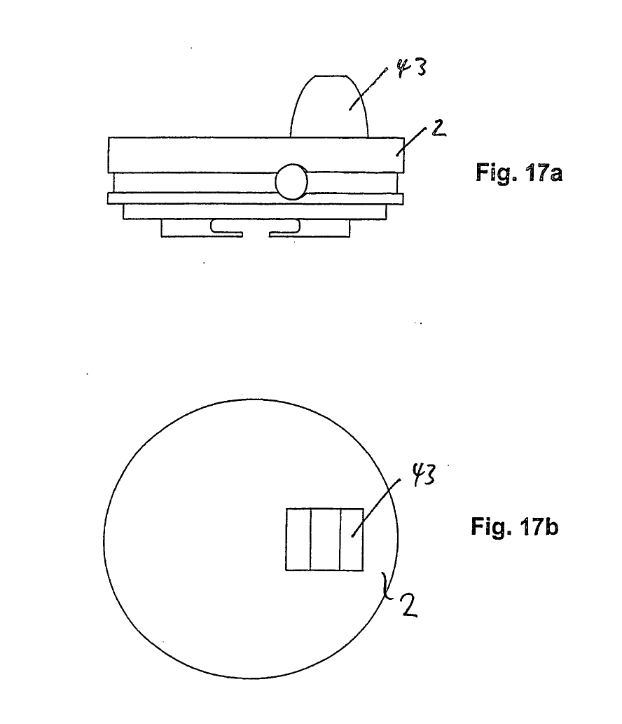

The embodiment of the coupling part 2 in FIGS. 17a and 17b consists in the arrangement of a master component 43 which serves to model and trace copies to be produced. According to the invention, the master component has been processed and hardened on the clamped coupling part 2 without it being necessary to unclamp or re-clamp the coupling part 2.

All the embodiments described in FIGS. 8 to 17 can be produced economically according to the invention. Due to the different material properties according to the invention of individual regions of the coupling parts 1 and 2, said coupling parts 1 and 2 or the workpieces or tools clamped therein can be processed without hitherto necessary unclamping and re-clamping.

1. A clamping device for a tool on a machine tool, comprising a first (1) and a second coupling part (2), the first coupling part (1) having strips (3) which are offset eccentrically and at an angle to one another and have boundary surfaces (4) for the accurate x-y positioning of the second coupling part (2), the second coupling part (2) having side surfaces (11) with elastic lips (5) for bearing against the boundary surfaces (4), and a connecting device being provided for the accurate z positioning of the first (1) and the second coupling part (2), wherein the second coupling part (2) consists of a single piece having various strength values, ductility values and hardness values, regions (7, 8) of the lips (5) having higher strength values, ductility values and/or hardness values than the other regions (9) of the lips (5) and/or regions (10) of the second coupling part (2).

2. The clamping device as claimed in claim 1, wherein the second coupling part (2) is produced from steel or from high-grade steel, and the side surfaces (11) with the lips (5) are surface-hardened, and the thickness d of the hardened region (7) is smaller than the thickness D of the lips (5).

3. The clamping device as claimed in claim 1, wherein the second coupling part (2) is produced as a cast part from steel or from high-grade steel, and the side surfaces (11) with the lips (5) are surface-hardened, and the thickness d of the hardened region (7) is smaller than the thickness D of the lips (5).

4. The clamping device as claimed in claim 1, wherein the second coupling part (2) is produced from steel or from high-grade steel, and the side surfaces (11) with the lips (5) are hardened, and the thickness d of the hardened region can be set according to the application.

5. The clamping device as claimed in claim 1, wherein ends (12) of the lips (5) which adjoin the strips (3) are formed in such a way that contact is effected when the first coupling part (1) is restrained together with the second coupling part (2).

6. The clamping device as claimed in claim 5, wherein the ends (12) of the lips (5) which adjoin the strips (3) have a curvature (13).

7. The clamping device as claimed in 1, wherein the lips (5) are formed differently in the x-y and/or z direction.

8. The clamping device as claimed in 1, wherein the second coupling part (2) can be adjusted by means of an integrated adjusting device (14).

9. The clamping device as claimed in 1, wherein openings (33) are arranged over the lips (5) in the second coupling part (2).

10. The clamping device as claimed in claim 9, wherein the openings (33) are of cylindrical design with threads, a respective adjusting device (46) being arranged in at least one opening (33) for setting the distance between the lip surface (47) and the bottom end (48) of the adjusting device (46).

11. The clamping device as claimed in claim 10, wherein the adjusting device (46) consists of an adjusting screw (46) and a peg (51, 52).

12. The clamping device as claimed in claim 11, wherein the peg (52) is made of a vibration-preventing material.

13. A clamping device for a tool on a machine tool, comprising a first (1) and a second coupling part (2), the first coupling part (1) having strips (3) which are offset eccentrically and at an angle to one another and have boundary surfaces (4) for the accurate x-y positioning of the second coupling part (2), the second coupling part (2) having side surfaces (11) with elastic lips (5) for bearing against the boundary surfaces (4), and a connecting device being provided for the accurate z positioning of the first (1) and the second coupling part (2), wherein the first coupling part (1) consists of a single piece having various strength values, ductility values and hardness values, regions of the strips (3) having higher strength values, ductility values and/or hardness values than the other regions of the strips (3) and/or regions of the first coupling part (1).

14. The clamping device as claimed in claim 11, wherein the first coupling part (1) is produced from steel or from high-grade steel, and the surfaces and/or boundary surfaces (4) are surface-hardened.

15. The clamping device as claimed in claim 11, wherein the first coupling part (1) is produced as a cast part from steel or from high-grade steel, and the surfaces and/or boundary surfaces (4) are surface-hardened.

16. The clamping device as claimed in claim 11, wherein the first coupling part (2) is produced from steel or from high-grade steel, and the surfaces and/or boundary surfaces (4) are surface-hardened, and the thickness of the hardened regions can be set according to the application.

17. The clamping device as claimed in claim 14, wherein the hardening process applied is an inductive hardening process, a laser hardening process or another hardening process for partial or surface hardening.

18. The clamping device as claimed in claim 13, wherein the connecting device (6) is one of a screwed connection, mechanically, pneumatically, hydraulically, and draw bolt.

19. The clamping device as claimed in claim 13, wherein the first (1) and/or the second coupling part (2) has a groove (18) having at least two notches (19) for gripping by means of a robot.

20. The clamping device as claimed in claim 13, wherein the first (1) and/or the second coupling part (2) has a processed device (20) for fastening a tool or workpiece (21).

21. The clamping device as claimed in claim 13, wherein the first (1) and/or second coupling part (2) has a shank (22) for fastening a copper electrode (23), the copper electrode (23) being connected in an electrically conductive manner by means of a spline tooth system (24) arranged inside or outside the shank.

22. The clamping device as claimed in claim 14, wherein the first (1) and/or the second coupling part (2) can be shaped in the respective top unhardened region (25) wherein the surface being hardened after the shaping.

23. The clamping device as claimed in claim 13, wherein the first (1) and/or second coupling part (2) a processed surface for the accurately positioned fastening of a mirror or another instrument.

24. The clamping device as claimed in claim 13, wherein the first (1) and/or the second coupling part (2) is arranged in the respectively top a specially formed further master for calibrating for the production.

25. A method of producing the clamping device of claim 14, wherein the first (1) and/or the second coupling part (2) is formed in the unhardened state according to known methods and the surface is thereafter hardened.

26. A method of producing the clamping device of claim 14, wherein the first (1) and/or the second coupling part (2) is hardened and then processed.

27. A method of producing the clamping device of claim 15, wherein the first (1) and/or the second coupling part (2) is thereafter produced as a cast part, and the surface is hardened and then processed.

28. A method of producing the clamping device of claim 15, wherein the first (1) and/or the second coupling part (2) is produced as a cast part and processed, and thereafter the surface is hardened.
